(19) United States
(12) Patent Application Publication
(10) Pub. No.: US 2022/0119671 A1
(43) Pub. Date: Apr. 21, 2022

(54) COMPOSITIONS AND METHODS FOR WATERPROOFING SURFACES

(71) Applicant: Beau Parmenter, Henderson, MI (US)

(72) Inventor: Beau Parmenter, Henderson, MI (US)

(21) Appl. No.: 17/502,673

(22) Filed: Oct. 15, 2021

Related U.S. Application Data
(60) Provisional application No. 63/092,434, filed on Oct. 15, 2020.

(51) Int. Cl. C09D 163/00; C09D 5/00; C09D 15/00

(52) U.S. Cl. CPC C09D 163/00; C09D 15/00; C09D 5/00

(57) ABSTRACT

A method for waterproofing a cabinet surface below a water source includes mixing an epoxy glaze to generate a waterproofing mixture; applying the waterproofing mixture to the cabinet surface below the water source; and curing the applied waterproofing mixture to generate a waterproof layer. In some embodiments, a continuous layer of the waterproofing layer is formed on the cabinet surface below the water source, such that a water leak originating from the water source is one or both of: maintained on the waterproof layer on the cabinet surface in a cabinet or caused to flow out from under the water source onto a floor in front of the cabinet. In some embodiments, the epoxy glaze is mixed with a water-based acrylic paint to generate the waterproofing mixture. The method may further include constructing a mold over the surface, such the waterproofing mixture is applied within the mold.

### CROSS REFERENCE TO RELATED APPLICATIONS

This application claims the priority benefit of U.S. Provisional Patent Application Ser. No. 63/092,434, filed Oct. 15, 2020, which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of construction and building materials and more specifically to the field of waterproof sealants and surfaces. Described herein are compositions and methods for waterproofing surfaces.

### BACKGROUND

Adequately waterproofing indoor surfaces can be an expensive and difficult process, but failure to do so can result in costly structural damage. If a leak goes undetected for even a few days, the water can cause substantial damage to wood and drywall by warping these components in addition to fostering the growth of molds and other fungi that eat away the wall while posing a health hazard to any occupants. In some worse case scenarios, if a leak in an upper story room goes undetected too long, the pooling water can run down the walls and yield serious damage to the walls and ceilings of the rooms below. In situations where such a leak occurs in an apartment or condominium complex with multiple owners, this can mean that one person's negligence can cause substantial damage to another's property. Especially in buildings where such a situation is possible, it is critical to properly waterproof appropriate surfaces.

Hidden surfaces and those with inconvenient access, such as those under kitchen or bathroom sinks or in various crawl spaces, are commonly overlooked during initial construction, leaving an unprotected, often wooden or particleboard, surface exposed to plumbing. Furthermore, some surfaces at risk can be oddly shaped, such as the case for some clever bathroom and kitchen cabinetry seeking to maximize drawer space in tight corners. Additionally, vulnerable gaps in a surface can sometimes appear as a result of remodeling or replacement of various plumbing fixtures (e.g., faucets, toilets, showers, tubs, etc.) when the new fixture does not perfectly match the profile of the old. In these examples, it can be very difficult or tedious to adequately fit appropriate waterproofing materials into these inconvenient surfaces or gaps.

### SUMMARY

There is a need for new and useful compositions and methods for waterproofing a surface. In some embodiments, the disclosure herein includes a composition for waterproofing a surface comprising: a water-based acrylic paint and an epoxy glaze. In some embodiments, the weight ratio of the paint to the epoxy glaze is about 1:2 to about 1:10. In other embodiments, the weight ratio of the paint to the epoxy glaze is about 1:6.5. In further embodiments, the composition is self-leveling.

In some embodiments, the disclosure herein includes for a method for waterproofing a surface comprising: mixing a water-based acrylic paint with an epoxy glaze to generate a waterproofing mixture, applying the waterproofing mixture to the surface, and curing the applied waterproofing mixture to generate a waterproof layer. In some embodiments, the weight ratio of the paint to the epoxy glaze is about 1:2 to about 1:10. In other embodiments, the weight ratio of the paint to the epoxy glaze is about 1:6.5. In some embodiments, the waterproof layer has a thickness of about 1.6 mm to about 50.8 mm (about 1/16 to about 2 inches). In other embodiments, the waterproof layer has a thickness of about 1.6 mm (about 1/16 of an inch). In further embodiments, the waterproof layer has a thickness of about 6.4 mm (about ¼ of an inch). In still further embodiments, the waterproof layer has a thickness of about 25.4 mm (about 1 inch). In some embodiments, the applied waterproofing mixture is cured for about 18 to about 96 hours. In some embodiments, there is negligible change in layer thickness between the applied waterproofing mixture and the waterproof layer.

In some embodiments, the method further comprises constructing a mold over the surface, and wherein the waterproofing mixture is applied within the mold. In some embodiments, the method further comprises applying one or more subsequent coats of the waterproofing mixture after at least a partial cure of a first application of the waterproofing mixture. In some embodiments, the first application of the waterproofing mixture and the one or more subsequent coats has a layer thickness not greater than about 6.4 mm (about ¼ an inch). In some embodiments, a total cure time for the first application of the waterproofing mixture and the one or more subsequent coats of the waterproofing mixture does not exceed 96 hours.

In some embodiments, the disclosure herein includes for a kit for producing a waterproofing mixture, the kit comprising: a first quantity of a water-based acrylic paint; and a second quantity of an epoxy glaze. In some embodiments, the first quantity of water-based acrylic paint and the second quantity of the epoxy glaze have a weight ratio of about 1:2 to about 1:10. In other embodiments, the weight ratio of the first quantity and the second quantity is about 1:6.5.

In some embodiments, the disclosure herein includes a method for waterproofing a cabinet surface below a water source. In some embodiments, the method includes mixing an epoxy glaze to generate a waterproofing mixture; applying the waterproofing mixture to the cabinet surface below the water source; and curing the applied waterproofing mixture to generate a waterproof layer, such that a continuous layer of the waterproofing layer is formed on the cabinet surface below the water source, and such that a water leak originating from the water source is one or both of: maintained on the waterproof layer on the cabinet surface in a cabinet or caused to flow out from under the water source onto a floor in front of the cabinet.

In some embodiments, the epoxy glaze is mixed with a water-based acrylic paint to generate the waterproofing mixture.

In some embodiments, a weight ratio of the paint to the epoxy glaze is about 1:2 to about 1:10. In some embodiments, the weight ratio of the paint to the epoxy glaze is about 1:6.5

In some embodiments, the waterproof layer has a thickness of about 1.6 mm to about 50.8 mm (about 1/16 to about 2 inches). In some embodiments, the waterproof layer has a thickness of about 1.6 mm (about 1/16 of an inch). In some embodiments, the waterproof layer has a thickness of about 6.4 mm (about ¼ of an inch). In some embodiments, the waterproof layer has a thickness of about 25.4 mm (about 1 inch).

In some embodiments, the applied waterproofing mixture is cured for about 18 to about 96 hours.

In some embodiments, there is negligible change in layer thickness between the applied waterproofing mixture and the waterproof layer.

In some embodiments, the method further includes constructing a mold over the surface, such that the waterproofing mixture is applied within the mold.

In some embodiments, the method further includes applying one or more subsequent coats of the waterproofing mixture after at least a partial cure of a first application of the waterproofing mixture. In some embodiments, the first application of the waterproofing mixture and the one or more subsequent coats has a layer thickness not greater than about 6.4 mm (about ¼ an inch).

In some embodiments, a total cure time for the first application of the waterproofing mixture and the one or more subsequent coats of the waterproofing mixture does not exceed 96 hours.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates one embodiment of a method for waterproofing a surface.

FIG. 2 depicts a view of an exemplary surface to be waterproofed.

FIG. 3 depicts an alternate view of an exemplary surface to be waterproofed

FIG. 4 depicts a partial application of a waterproofing mixture to a surface to be waterproofed.

FIG. 5 depicts a full application of a waterproofing mixture to a surface before curing.

FIG. 6 depicts an alternative view of a full application of a waterproofing mixture to a surface before curing.

FIG. 7 depicts a fully cured waterproof layer.

FIG. 8 depicts an alternative view of a fully cured waterproof layer.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

In apartment complexes or other stacked living arrangements or homes with multiple floors, a leak on an upper floor, gone unnoticed, can result in the leak causing damage to multiple floors beneath the leaky unit or room. Leaks often go unnoticed because the water is absorbed into the cabinet, floor underneath the cabinet, walls behind the cabinet, etc. As such, a leak, even when slow or small, can wreak havoc on multiple floors or cause catastrophic consequences, like floor or building collapse, before someone notices. Currently, cabinets are only outfitted with the typical veneer or clear coat, which affords little in the way of leak protection. Accordingly, new compositions and methods are needed to provide for waterproofing cabinet surfaces.

Disclosed herein are compositions and methods for waterproofing surfaces. The embodiments disclosed herein provide cheaper and more convenient solutions to waterproofing surfaces. As described herein in various embodiments, the composition for waterproofing a surface that is used in the disclosed methods herein can be mixed and poured over a surface. In some embodiments, minimal or no spreading and/or leveling is required to ensure a full coating that is also aesthetically smooth and consistent. The mixture, once it cures, becomes a waterproof layer. Due to its liquid application, the mixture therefore easily fills in any gaps and oddly shaped corners of a vulnerable surface without the need for detailed measurements of the dimensions of the surface or for any sizing of waterproof liners that must be cut to fit the surface and around any plumping fixtures. The embodiments described herein allow for a simple pour that can more confidently provide full coverage of a waterproof layer to a vulnerable surface, regardless of its shape and size.

### Compositions

Embodiments of the compositions disclosed herein functions to waterproof surfaces. In many embodiments, the compositions are used for waterproofing indoor surfaces, such as wooden or particleboard cabinetry and other surfaces, but can additionally or alternatively be used for any suitable applications, such as to tile, laminate, and stone surfaces including floors. In some embodiments, the composition can be applied to outdoor surfaces. In many embodiments, the composition can be adapted to function for any suitable surface and material that needs to be waterproofed.

In many embodiments, the composition, a “waterproofing mixture,” comprises an epoxy resin. In some embodiments, the waterproofing mixture comprises a water-based acrylic paint and an epoxy glaze. In some embodiments, these components are mixed at a weight ratio of about 1:2 to about 1:10, respectively. In other embodiments, these components are instead mixed at a weight ratio of about 1:4 to about 1:7, respectively. In still a further embodiment, these components are mixed at a weight ratio of about 1:6.5, respectively.

In many embodiments, the water-based acrylic paint of the waterproofing mixture can be selected from a wide variety of available paints that employ a water-based acrylic resin and water as a solvent. In many places, such paints can be labeled as “enamel” paints, though, as one of skill in the art will appreciate, the term “enamel” can be inconsistent in the industry and should be verified before using as part of a waterproofing mixture as disclosed herein. The mixture of this type of paint with an epoxy resin creates an opaque, durable surface that is both aesthetically pleasing and presents physical properties amenable to facile application during installation. In most embodiments, the water-based acrylic paint can have any pigment. In some embodiments, a white water-based acrylic paint is used. Furthermore, the water-based acrylic paint can be adapted to have a particular finish including but not limited to matte, satin, gloss, etc. In some embodiments, the water-based acrylic paint has a gloss finish. In some embodiments, Rust-oleum® Painter's Touch® Ultra Cover Multi-Purpose Gloss Brush-On Paint Gloss White (the MSDS of which is herein incorporated by reference in its entirety) is used.

In some embodiments, a waterproofing mixture may include a tint. For example, the tint may include one or more of: oxirane 2,2′-4-butylidenebisphenyleneoxymethylene (DGEBA), titanium dioxide, alkyl (C12-14) glycidyl ether, calcium carbonate, or a combination thereof. In some embodiments, the percent weight of DGEBA may be about 30% to about 60%; about 35% to about 55%; about 40% to about 50%; about 42% to about 46%; or any range or subrange therebetween. In some embodiments, the percent weight of titanium dioxide may be about 30% to about 60%; about 35% to about 55%; about 40% to about 50%; about 46% to about 49%; or any range or subrange therebetween. In some embodiments, the percent weight of alkyl (C12-14) glycidyl ether may be about 1% to about 10%; about 2% to about 9%; about 3% to about 8%; about 4% to about 7%; about 4% to about 6%; or any range or subrange therebetween. In some embodiments, the percent weight of calcium carbonate may be about 0% to about 10%; about 1% to about 9%; about 2% to about 8%; about 2% to about 7%; about 2% to about 6%; about 2% to about 5%; about 2% to about 4%; about 2.5% to about 3.5%; or any range or subrange therebetween. In some embodiments, Simiron™ Moisture Vapor Barrier (MVB) White Tint Pack (the MSDS of which is herein incorporated by reference in its entirety) is used.

In many embodiments, the epoxy glaze of the waterproofing mixture can be selected from a wide variety of available epoxy hard coatings. These coatings typically include an epoxy resin and a hardener compound that are mixed together in a certain proportion. In some embodiments, a 50:50 volume mix of epoxy resin and hardener is used to generate the epoxy glaze. In other embodiments, a 2:1 volume mix of epoxy resin and hardener is used to generate the epoxy glaze. One of skill in the art will appreciate that various volume and weight ratios can be employed depending on the properties of the specific resin and hardener used. In some embodiments, the epoxy glaze, additionally or alternatively, comprises one or more amines (i.e., an organic compound derived from ammonia by replacement of one or more hydrogen atoms by organic groups). Exemplary, non-limiting embodiments of amines include: trimethylamine, aniline or aromatic amines, monochloroamine, alkyl amines, etc. In some embodiments, an epoxy resin includes or comprises, at least in part, propane, 2,2-bis[p-(2,3-epoxypropoxy)phenyl]-, polymers. The percent weight of propane, 2,2-bis[p-(2,3-epoxypropoxy)phenyl]-, polymers in the resin may be about 0% to about 100%; about 25% to about 75%; about 40% to about 60%; or any range or subrange therebetween. In one embodiment, Simiron™ Casting Resin (the MSDS of which is herein incorporated by reference in its entirety) may be used.

In some embodiments, a resin may include 2,2-Bis[4-(glycidyloxy)phenyl]propane 4,4′-Isopropylidenediphenol diglycidyl ether or bisphenol A diglycidyl ether, as described below. In one embodiment, Simiron™ Tabletop Resin part A and/or Resin part B (the MSDS of which is herein incorporated by reference in its entirety) may be used.

The resulting liquid coating is then applied to a surface and cured to generate a shiny finish. One of skill in the art will appreciate the various means to cure an epoxy resin which can include but is not limited to letting the epoxy glaze dry at a certain temperature in a dust-free environment for a certain duration of time. In some embodiments, the epoxy glaze can have a pigment, though in many embodiments, the epoxy glaze does not include a pigment. In some embodiments, Famowood® Glaze Coat (the MSDS of which is herein incorporated by reference in its entirety) is used. In some embodiments, Simiron™ Table Top Epoxy (the MSDS of which is herein incorporated by reference in its entirety) is used.

In some embodiments, an activator may be added to one or more mixtures described herein. For example, an activator may include one or more of: 2,2-Bis[4-(glycidyloxy)phenyl]propane 4,4′-Isopropylidenediphenol diglycidyl ether or bisphenol A diglycidyl ether; 3-aminomethyl-3,5,5-trimethylcyclohexylamine; benzyl alcohol; or a combination thereof. For example, 2,2-Bis[4-(glycidyloxy)phenyl]propane 4,4′-Isopropylidenediphenol diglycidyl ether or bisphenol A diglycidyl ether may have a weight percentage of about 20% to about 60%; about 25% to about 55%; about 30% to about 45%; or any range or subrange therebetween. Further for example, 3-aminomethyl-3,5,5-trimethylcyclohexylamine may have a weight percentage of about 20% to about 60%; about 25% to about 55%; about 30% to about 45%; about 30% to about 40%; or any range or subrange therebetween. For example, benzyl alcohol may have a weight percentage of about 1% to about 30%; about 5% to about 25%; about 10% to about 20%; or any range or subrange therebetween. In one embodiment, Simiron™ Casting Activator (the MSDS of which is herein incorporated by reference in its entirety) may be used.

In additional embodiments, the compositions expressed herein can be packaged as a kit for waterproofing a surface. In some embodiments, the kit can comprise a water-based acrylic paint and an epoxy glaze. The water-based acrylic paint can be prepackaged in a first quantity and the epoxy glaze can be prepackaged in a second quantity (i.e., prepackaged and separated quantities of its epoxy resin and hardener components), such that, when combined according to the methods expressed herein, a user generates a predetermined volume of the waterproofing mixture for application to a surface to be waterproofed. In some embodiments, the first quantity of the water-based acrylic paint and the second quantity of the epoxy resin have a weight ratio from about 1:2 to about 1:10. In other embodiments, the weight ratio of the first quantity to the second quantity is about 1:6.5. In various embodiments, the kit can comprise further materials or components, such as additional tints or activators as described herein.

### Methods

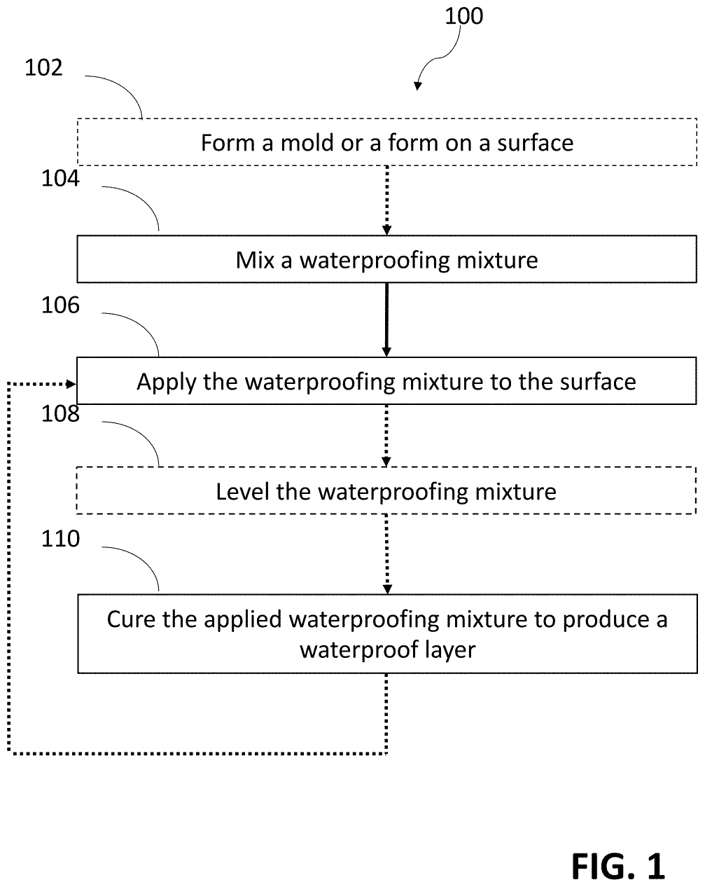

As shown in FIG. 1, the disclosure herein includes a method 100 for waterproofing a cabinet surface below a water source. In some embodiments, the method functions to waterproof indoor surfaces, such as wooden or particleboard cabinetry and other surfaces, but can additionally or alternatively be used for any suitable applications, such as to tile, laminate, and stone surfaces including floors. In some embodiments, the method can function to waterproof outdoor surfaces. In many embodiments, the method 100 can be adapted to function for any suitable surface and material that needs to be waterproofed.

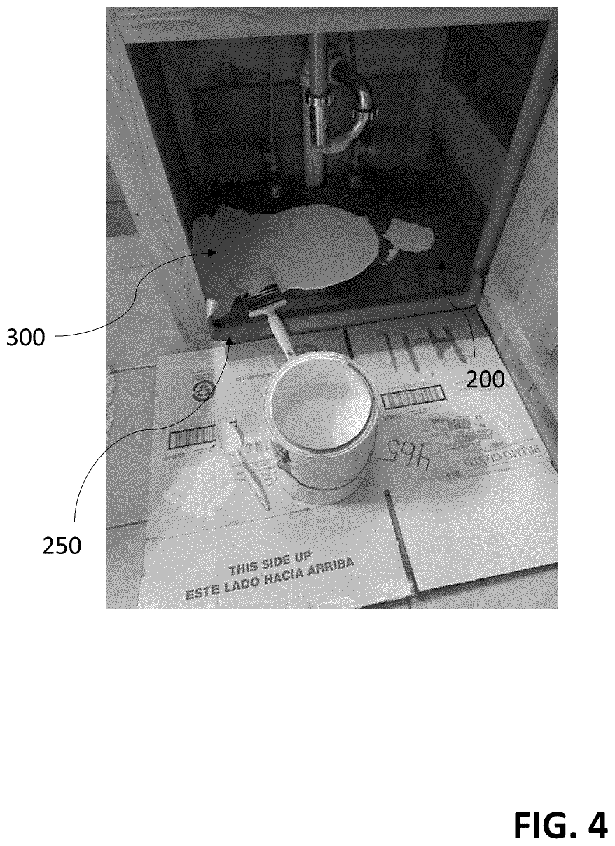

As shown in FIG. 1, one embodiment of a method for waterproofing a cabinet surface below a water source includes forming a mold or a form on a surface in optional step 102. Due to the liquid nature of the mixture during application, it can be effective to produce a mold or form on the cabinet surface to be waterproofed. The mold or form can be constructed out of any material that can define the area to be waterproofed by the waterproofing mixture. In some embodiments, the form can be constructed out of one or more materials that are easily removed such as, but not limited to: plywood, balsa wood, particleboard, or painters tape. For example, if the surface to be waterproofed is a cabinet beneath a sink and the cabinet does not have a lip, optional step 102 can be performed to provide a barrier across the open face of the cabinet to prevent the waterproofing mixture from spilling out during application (see FIG. 4 for an exemplary depiction).

At step 104, the method 100 provides for mixing the waterproofing mixture. In some embodiments, the waterproofing mixture comprises an epoxy resin. In certain embodiments, the waterproofing mixture comprises a water-based acrylic paint and an epoxy glaze, as described above. In some embodiments, these components are mixed at a weight ratio of about 1:2 to about 1:10, respectively. In other embodiments, these components are instead mixed at a weight ratio of about 1:4 to about 1:7, respectively. In other embodiments, these components are instead mixed at a weight ratio of about 1:6 to about 1:7, respectively. In still a further embodiment, these components are mixed at a weight ratio of about 1:6.5, respectively. In additional embodiments, the resin and the hardener of the epoxy glaze are mixed first before the addition of the paint. In further embodiments, the waterproofing mixture comprises additional components such as an additional tint and/or an activator. In those embodiments, the additional components are mixed into the waterproofing mixture at this step.

At step 106, the method 100 provides for applying the waterproofing mixture to the cabinet surface below the water source. In some embodiments, the mixture can be applied by pouring it onto the cabinet surface. In other embodiments, the mixture is applied by painting or spreading it onto the cabinet surface with a brush or tool. In some embodiments, the mixture is self-leveling and requires no further interaction after application to level out into a smooth, consistent, and/or continuous layer. In embodiments of the method 100 where step 102 was performed and a mold or form is in place, the mixture should be applied only within the mold or form.

At step 108, the method 100 optionally includes for leveling the waterproofing mixture on the surface. In some embodiments, this step can comprise using a brush or other tool to evenly distribute the mixture on the surface to generate a smooth, level layer. In some embodiments, leveling the waterproofing mixture can comprise a combing motion performed in a singular general direction across the surface. In embodiments wherein the waterproofing mixture is self-leveling, this optional step 108 can be skipped. In further embodiments, where an uneven surface is desired, the mixture can lack self-leveling properties and step 108 can be skipped.

At step 110, the method 100 includes for curing the applied waterproofing mixture to generate a waterproof layer. Curing the waterproofing mixture can comprise in some embodiments leaving the mixture to sit undisturbed at room temperature for a duration of time. In other embodiments, it further comprises leaving the mixture to sit undisturbed and adjusting the temperature of the room or applying a certain temperature to the mixture. In some embodiments, the curing temperature is about 4.4 degrees Celsius to about 26.7 degrees Celsius (about 40° F. to about 80° F.). In other embodiments, the curing temperature is about 7.2 degrees Celsius to about 23.9 degrees Celsius (about 45° F. to about 75° F.). In still further embodiments, the curing temperature is about 21.1 degrees Celsius (about 70° F.). In embodiments where heat is applied to the applied waterproofing mixture, various heating tools can used that will be appreciated by those of skill in the art. In certain embodiments, these tools can include a torch or a hair dryer. In many embodiments, the heating tool should be held at least 6 inches away from the curing surface. In some embodiments, the area should be dust-free while the mixture cures. In other embodiments, the area can be humidity-controlled during the curing process. In some embodiments, the humidity of the area can be kept to less than or equal to about 60%.

The duration of time of the curing step 110 can depend upon the thickness of the waterproof layer to be dried and the conditions of area around it. In some embodiments, the waterproof layer becomes dry to touch after about 2 to about 8 hours. In embodiments where the layer thickness is about 1.6 mm (about 1/16 of an inch), the waterproof layer can become dry to the touch after about 3 hours. In other embodiments where the layer thickness is about 25.4 mm (about 1 inch), the waterproof layer can become dry to the touch after about 6 hours. However, in many embodiments, the waterproof layer can be cured further in order to ensure proper performance before use. This drying time for safe use is about 18 to 96 hours, in many embodiments. In some embodiments, the drying time for safe use is about 24 hours. In other embodiments, the drying time for safe use is about 72 hours.

In some embodiments, the steps of applying and/or curing include creating or ensuring that a continuous layer of the waterproofing layer is formed on the cabinet surface below the water source, such that a water leak originating from the water source is one or both of: maintained on the waterproof layer on the cabinet surface in a cabinet (instead of penetrating the underlying cabinet material) or caused to flow out from under the water source, at least partially off the waterproof layer, onto a floor in front of the cabinet. The goal of the waterproof layer on the cabinet surface under the water source is to ensure that a leak is detected early rather than after damage to the cabinet, floors, walls, ceilings, etc. below the water source has occurred. By forcing the water to remain in the cabinet and/or to flow out onto the floor in front of the cabinet, a leak can be detected early, saving homeowners, lessors, landlords, businesses, etc. time and resources that may otherwise be directed towards fixing a much larger leak than how it originally started.

The resulting waterproof layer can have a thickness of about 1.6 mm to about 50.8 mm (about 1/16 to about 2 inches), in some embodiments. In other embodiments, the waterproof layer can have a thickness of about 1.6 mm to about 12.7 mm (about 1/16 to about ½ of an inch). In further embodiments, the waterproof layer has a thickness of about 1.6 mm (about 1/16 of an inch), while in other embodiments, the waterproof layer has a thickness of about 6.4 mm (about ¼ an inch). In additional embodiments, the waterproof layer has a thickness of about 3.2 mm (about ⅛ an inch). In still further embodiments, the waterproof layer can have a thickness of about 12.7 mm to about 38.1 mm (½ to about 1.5 inches). In some embodiments, the waterproof layer can have a thickness of about 25.4 mm (about 1 inch).

In further embodiments, the thickness across a layer has a variance of less than about 1.6 mm (about 1/16 of an inch). In other embodiments, the surface can have a thickness variance of greater than 1.6 mm (about 1/16 of an inch). In some embodiments, the dry thickness of the waterproof layer is determined by the thickness of the wet mixture applied to any given spot. In many embodiments, there can be a negligible change in layer thickness between the wet application and fully dried layer. In these embodiments, wet application therefore dries into a solid surface with negligible loss in thickness. For example, a wet layer thickness of about 6.4 mm (about ¼ of an inch) will dry and become a waterproof layer having a thickness of about 6.4 mm (about ¼ of an inch) in these embodiments.

In some embodiments of the method, the method includes returning to step 106 to apply one or more additional layers of the waterproofing mixture on top of a cured or partially cured waterproof layer. This allows for a sequential buildup of thickness of the final waterproof layer which, in certain circumstances for certain surfaces to be waterproofed, yields a more durable surface. In these embodiments, each sequential layer, including the initial layer, should be no thicker than about 6.4 mm (about ¼ of an inch). In some embodiments, each sequential layer, including the initial layer, should be no thicker than about 3.2 mm (about ⅛ of an inch). In some embodiments where leveling of the waterproofing mixture is required, only the initial layer can be leveled. In some of these embodiments, leveling subsequent layers can disrupt the curing progress of the layers below. In various embodiments, the cure time or partial cure time between the application of each layer of the waterproofing mixture can vary. In some embodiments, a second and third layer can be applied after the previous layer has cured for about 3 to about 6 hours. In other embodiments, a second and third layer can be applied after the previous layer has cured for about 4 to about 5 hours. In further embodiments, a fourth or further layer can be applied after the previous layer has cured for about 20 to 50 hours. In some embodiments a fourth or further layer can be applied after the previously layer has cured for about 24 to about 48 hours. In some embodiments, all layers can be applied and cured within a maximum of about 56 to 96 hours. In further embodiments, all layers can be applied and cured within 72 hours.

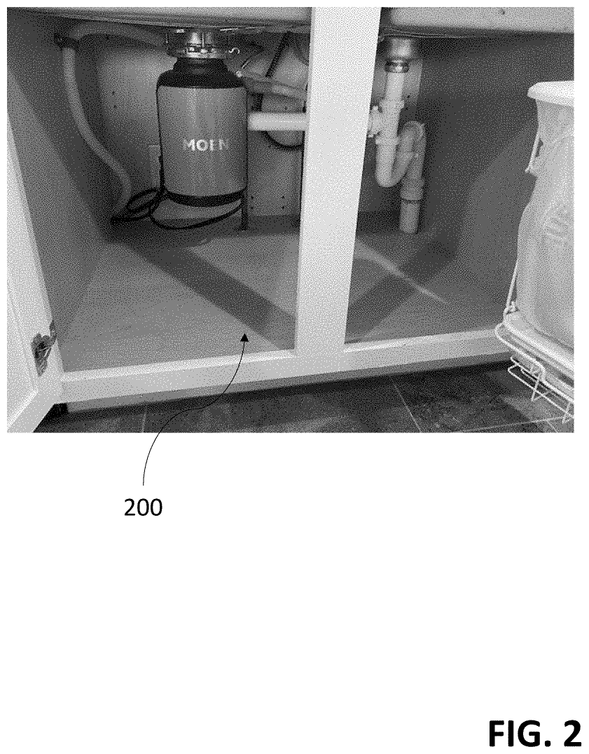

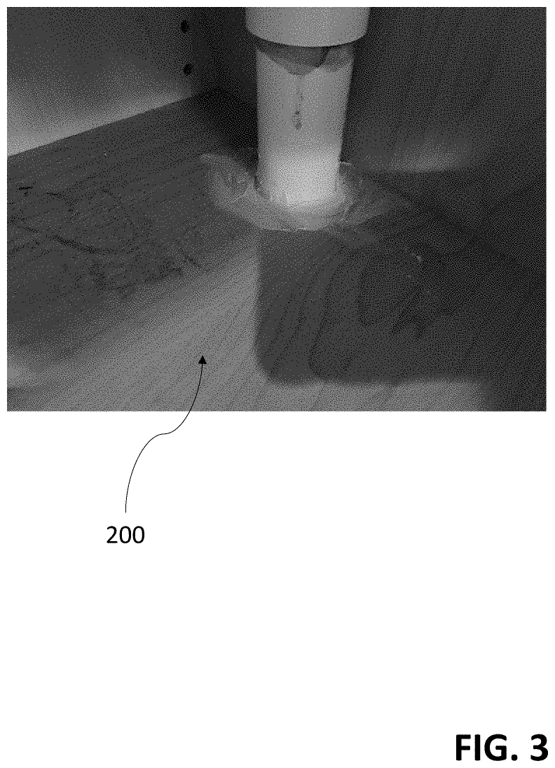

FIGS. 2 and 3 both show various views of an exemplary cabinet surface 200 to be waterproofed. In some embodiments, the cabinet surface 200 is of wooden or wood-like material (e.g., particleboard) that is exposed to various plumbing features (e.g., for a water source). If the plumbing features leak, the cabinet surface 200, and potentially even floors and surfaces below cabinet surface 200, is particularly vulnerable to rot and other costly and hazardous consequences of water damage as discussed above.

FIG. 4 depicts a partial application of a waterproofing mixture 300 to an exemplary surface 200. Once mixed, the waterproofing mixture can be painted, poured, or otherwise applied to the surface. A mold or frame 250 (e.g., painters tape) can be secured around various portions of the surface 200 such as its lip at the mouth of the cabinetry in order to prevent a spilling of the waterproofing mixture 300. Molds and frames 250 can also be used in various embodiments to limit the waterproofing mixture 300 to only a portion of a surface 200 if a full coating of the surface 200 is undesired.

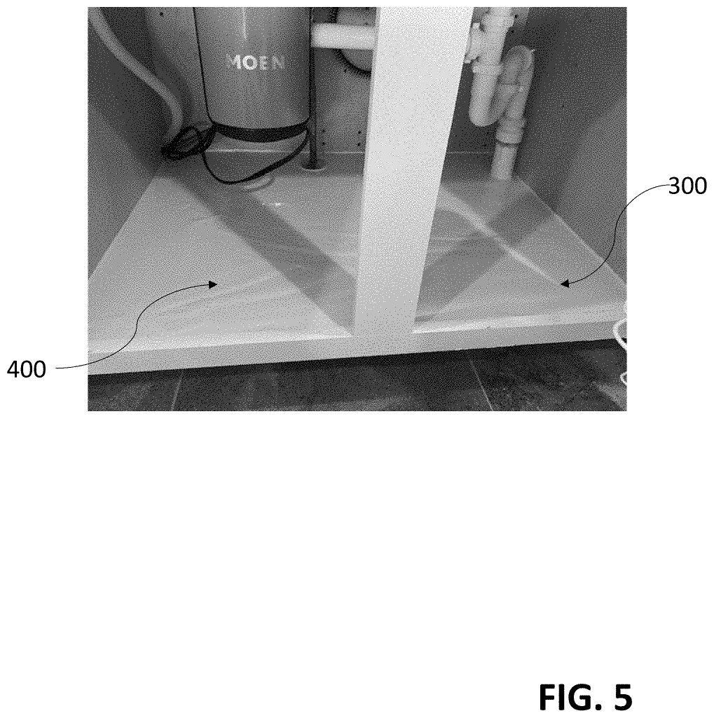

FIG. 5 depicts a full application of a waterproofing mixture 300 that is not yet cured. In various embodiments, when the waterproofing mixture 300 is freshly applied, the waterproofing mixture will present texture or unevenness 400. In some embodiments, texture 400 can be smoothed out or leveled by hand using various tools, as appreciated by those skilled in the art as discussed above herein. In other embodiments, the waterproofing mixture 300 is self-leveling, and the texture 400 will smooth itself as the waterproofing mixture 300 sits curing undisturbed.

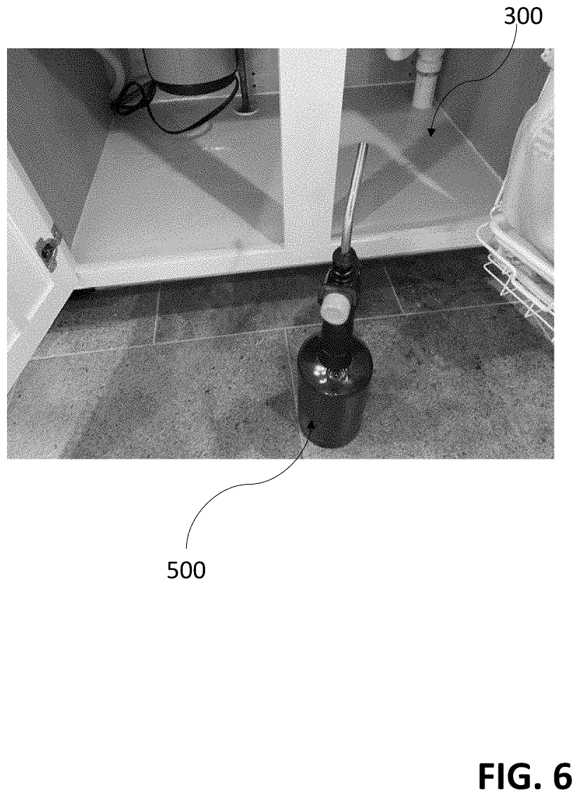

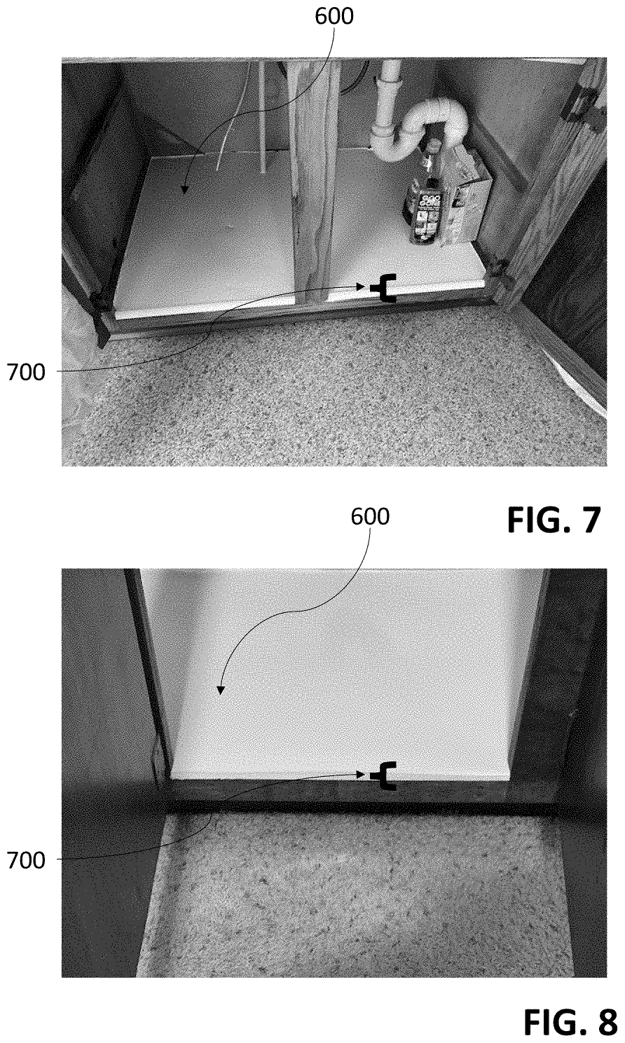

FIG. 6 depicts an alternative view of a full application of waterproofing mixture 300 that is not yet cured. In some embodiments, the applied waterproofing mixture is allowed to cure under room temperature and conditions or under an applied temperature and conditions for a duration of time, as described herein. In some embodiments, a torch 500 or other tool as discussed above herein is used to apply a suitable temperature to the applied waterproofing mixture 300 for curing. FIGS. 7 and 8 both depict various views of a fully cured waterproof layer 600. The layer 600 has a thickness 700 according to the parameters as described herein.

As used in the description and claims, the singular form “a”, “an” and “the” include both singular and plural references unless the context clearly dictates otherwise. For example, the term “surface” may include, and is contemplated to include, a plurality of surfaces. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for waterproofing a cabinet surface below a water source, the method comprising:
mixing an epoxy glaze to generate a waterproofing mixture;
applying the waterproofing mixture to the cabinet surface below the water source; and
curing the applied waterproofing mixture to generate a waterproof layer,
such that a continuous layer of the waterproofing layer is formed on the cabinet surface below the water source, and
such that a water leak originating from the water source is one or both of:
maintained on the waterproof layer on the cabinet surface in a cabinet or caused to flow out from under the water source onto a floor in front of the cabinet.

2. The method of claim 1, wherein the epoxy glaze is mixed with a water-based acrylic paint to generate the waterproofing mixture.

3. The method of claim 2, wherein a weight ratio of the paint to the epoxy glaze is about 1:2 to about 1:10.

4. The method of claim 3, wherein the weight ratio of the paint to the epoxy glaze is about 1:6.5

5. The method of claim 1, wherein the waterproof layer has a thickness of about 1.6 mm to about 50.8 mm (about 1/16 to about 2 inches).

6. The method of claim 5, wherein the waterproof layer has a thickness of about 1.6 mm (about 1/16 of an inch).

7. The method of claim 6, wherein the waterproof layer has a thickness of about 6.4 mm (about ¼ of an inch).

8. The method of claim 7, wherein the waterproof layer has a thickness of about 25.4 mm (about 1 inch).

9. The method of claim 1, wherein the applied waterproofing mixture is cured for about 18 to about 96 hours.

10. The method of claim 1, wherein there is negligible change in layer thickness between the applied waterproofing mixture and the waterproof layer.

11. The method of claim 1, further comprising: constructing a mold over the surface; and
wherein the waterproofing mixture is applied within the mold.

12. The method of claim 1, further comprising applying one or more subsequent coats of the waterproofing mixture after at least a partial cure of a first application of the waterproofing mixture.

13. The method of claim 12, wherein the first application of the waterproofing mixture and the one or more subsequent coats has a layer thickness not greater than about 6.4 mm (about ¼ an inch).

14. The method of claim 12, wherein a total cure time for the first application of the waterproofing mixture and the one or more subsequent coats of the waterproofing mixture does not exceed 96 hours.

15. A composition for waterproofing a cabinet surface below a water source, the composition comprising:
a water-based acrylic paint; and
an epoxy glaze.

16. The composition of claim 15, wherein the weight ratio of the paint to the epoxy glaze is about 1:2 to about 1:10.

17. The composition of claim 16, wherein the weight ratio of the paint to the epoxy glaze is about 1:6.5.

18. A kit for producing a waterproofing mixture for application to a cabinet surface below a water source, the kit comprising:
a first quantity of a water-based acrylic paint; and
a second quantity of an epoxy glaze.

19. The kit of claim 18, wherein the first quantity of water-based acrylic paint and the second quantity of the epoxy glaze have a weight ratio of about 1:2 to about 1:10.

20. The kit of claim 19, wherein the weight ratio of the first quantity and the second quantity is about 1:6.5.
